(19) United States
(12) Patent Application Publication
(10) Pub. No.: US 2019/0378144 A1
(43) Pub. Date: Dec. 12, 2019

(54) SYSTEMS, DEVICES AND METHODS FOR PROVIDING A DIGITAL EXPERIENCE

(71) Applicant: Sneaker Con Digital Inc., Elmhurst, NY (US)

(72) Inventors: Alan VINOGRADOV, Nyack, NY (US); Barris VINOGRADOV, Brooklyn, NY (US)

(73) Assignee: Sneaker Con Digital Inc., Elmhurst, NY (US)

(21) Appl. No.: 16/436,854

(22) Filed: Jun. 10, 2019

Related U.S. Application Data
(60) Provisional application No. 62/682,901, filed on Jun. 9, 2018.

(51) Int. Cl. G06Q 30/00; G06Q 30/06; G06Q 10/08

(52) U.S. Cl. CPC G06Q 30/018; G06Q 30/0643; G06Q 10/0833; G06Q 30/0607

(57) ABSTRACT

A system, an apparatus, a method and a computer program product provide a digital experience for digital commerce aspects of a community. The system includes one or more databases configured to store data of one or more products, a server that includes at least one memory configured to store computer-executable instructions, and at least one processor configured to execute those computer-executable instructions. Those instructions include product display instructions for providing information about the products to a user of the community. The computer-executable instructions further include product purchase instructions for enabling the user to purchase products. The computer-executable instructions further include product delivery instructions for enabling delivery tracking of purchased products. The computer-executable instructions further include product authentication instructions for capturing details of an authenticated product by scanning an authentication tag attached to the products.

### CROSS-REFERENCE TO RELATED APPLICATION

This application claims the benefit under 35 U.S.C. § 119(e) of the priority of U.S. Provisional Patent Application Ser. No. 62/682,901, filed Jun. 9, 2018 and entitled “Digital Commerce Module”, the entirety of which is hereby incorporated by reference for all purposes.

### TECHNICAL FIELD

The present disclosure generally relates to websites and, more particularly, to websites that provide for online commerce.

### SUMMARY

Digital commerce refers to conducting commerce via the Internet. It involves performing buying, selling, promoting and facilitating sale and purchase of goods and services online using so-called digital channels. Digital channels may be in the form of websites, applications or apps, platforms and other product based and general-purpose software modules for enabling conducting of digital commerce. The software modules available for conducting digital commerce generally provide capabilities related to viewing of information for a product, purchase of and providing delivery details for the product.

However, these modules generally lack the capabilities for providing robust authentication techniques for the product available through a channel, such as a digital commerce platform. It is therefore required to find an effective solution that increases reliability, genuineness and consumer trust in products available for sale and purchase through these digital commerce platforms.

Systems, methods, an apparatus, and a computer program product of the invention provide a digital experience of aspects of a community. In some embodiments, there is a system for providing the digital experience through the provision of digital commerce capabilities to the users of the community, and the phrases “digital experience” and “digital commerce” may be used interchangeable hereinafter.

A computer-implemented system, such as software, for providing digital experience of aspects of a community includes one or more databases configured to store data of one or more products. A server includes at least one memory configured to store computer-executable instructions for product-display that are configured to provide information about plural products to a user. The computer-executable instructions further include product purchase instructions for enabling the user to purchase at least one of the one or more products. The computer-executable instructions further include product delivery instructions that are configured to enable tracking of delivery of a product bought. The computer-executable instructions also include product authentication instructions that are configured to enable capturing details of an authenticated product by scanning an authentication tag attached to a product. The system also includes at least one processor configured to execute the computer code to perform the digital commerce.

In other embodiments, the at least one processor is further configured to execute the product authentication instructions for enabling adding of the authenticated product to a user profile, wherein the user profile can be characterized as an online profile which includes data of the user. In some embodiments, the authentication tag may include one or more of a bar code, a QR code, a holographic image, or a near field communication authentication tag. The authentication tag may be rendered inoperable when detached from the product. The at least one processor may be further configured to execute the product purchase instructions for enabling the user to sell the one or more products. The at least one processor may be further configured to execute the product purchase instructions for enabling the user to make a price offer for selling the one or more products.

In other embodiments, the at least one processor is further configured to execute the computer-executable instructions to identify and display a plurality of virtual events associated with at least one of the one or more products. The plural virtual events include any one or a combination of a social community, a virtual auction, a virtual sale, a virtual forum, a virtual discussion, or an e-commerce event. The product purchase information is integrated with payment details of the user.

In some embodiments, the at least one processor is further configured to execute the product delivery instructions associated with product delivery data, which is further integrated with location capturing data, wherein the location capturing data is characterized by a current location data of the user. The location capturing data can be further used to obtain a delivery schedule from the application based on the current location.

In another aspect, a method provides a digital experience of aspects of a community and includes displaying information about one or more products to a user. The method further includes initiating a product purchase to enable the user to purchase at least one of the one or more products. Further, the method includes tracking product delivery of the at least one or more purchased products. Also, the method includes capturing product authentication information by scanning an authentication tag attached to at least one of the one or more products.

According to other embodiments, the method further includes capturing product authentication information, which further includes adding of the authenticated product to a user profile, wherein the user profile comprises data of a user. In some embodiments, the authentication tag may include one or more of a bar code, a QR code, a holographic image, or a near field communication authentication tag. The authentication tag may be rendered inoperable when detached from the product. The method may also include enabling the user to sell the one or more products. The method also includes enabling the user to make a price offer for selling the one or more products. The method may also include displaying plural virtual events associated with at least one of the one or more products.

According to other embodiments, the method further includes the plurality of virtual events including any one or a combination of a social community, a virtual auction, a virtual sale, a virtual forum, a virtual discussion, or an e-commerce event.

In another aspect, a method provides a digital experience of aspects of a community and includes performing a two-way communication between a first member of the community and a second member of the community. The two-way communication includes performing at least one of: receiving a proposal for a commercial transaction from the first member to the second member, enabling completion of the proposed commercial transaction between the first member and the second member, directing shipping of a product that is related to the completed commercial transaction, and posting a review about the community and the completed commercial transaction. The posting may include displaying information about the product to a user of the community.

In yet another aspect, a device includes at least one memory having stored therein, computer-executable instructions for providing digital experience and at least one processor. That processor is configured to execute the instructions to: display information about one or more products to a user; initiating a product purchase to enable the user to purchase at least one of the one or more products, tracking product delivery of the at least one or more purchased products, and capturing product authentication information by scanning an authentication tag attached to at least one of the one or more products.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a system for providing a digital experience, in accordance with one or more example embodiments of the present invention;

FIG. 2 exemplarily illustrates a diagram of display of a product according to product display instructions, in accordance with one or more example embodiments of the present invention;

FIGS. 3A and 3B illustrate exemplary diagrams of display of products according to product purchase instructions, in accordance with one or more example embodiments of the present invention;

FIG. 4 exemplarily illustrates a schematic diagram of a display in accordance with product authentication instructions, in accordance with one or more example embodiments of the present invention;

FIG. 5 illustrates a flowchart of a method for providing digital experience, in accordance with one or more example embodiments of the present invention; and

FIGS. 6A and 6B illustrate exemplary scenarios of having an authentication tag attached to or detached from a product, in accordance with one or more example embodiments of the present invention.

### DETAILED DESCRIPTION

In the following description, for purposes of explanation, numerous specific details are set forth to provide a thorough understanding of the present disclosure. However, it will be apparent to one skilled in the art that the present disclosure may be practiced without these specific details, as long as the elements of the invention are used. In other instances, devices and methods are shown in block diagram form to effectively communicate without obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for purposes of description and should not be regarded as limiting. Any heading utilized within this description is for convenience only and has no legal or limiting effect.

As used in this specification and claims, the terms “for example.” “For instance.” and “such as, and the verbs “comprising” “having” “including,” and their other verb forms, when used in conjunction with a listing of one or more components or other items, are each to be construed as open ended, meaning that that the listing is not to be considered as excluding other, additional components or items. Other terms are to be construed using their broadest reasonable meaning unless they are used in a context that requires a different interpretation.

The term ‘user equipment’ may be used to refer to any user accessible device such as a mobile phone, a smartphone, a portable computer, and the like that is portable in itself or as a part of another portable object.

In accordance with various embodiments of the invention disclosed herein, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor readable medium. For example, a server can include one or more computers operating as a web server, data source server, or other type of computer server in a manner to fulfill described roles, responsibilities, or functions.

Within the context of this document, the disclosed devices or systems are also deemed to comprise computing devices having a processor and a non-transitory memory storing instructions executable by the processor that cause the device to control, manage, or otherwise manipulate the features of the devices or systems. Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art.

An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of the above-referenced terms, and similar terms, are to be associated with the appropriate physical quantities and are merely convenient labels applied to these quantities.

Unless specifically stated otherwise, as apparent from the discussion herein, it is appreciated that throughout the description, discussions utilizing terms such as “generating,” or “monitoring,” or “displaying,” or “tracking,” or “identifying,” “or receiving,” or the like, refer to the action and processes of a computer system, or similar electronic computing device. Those devices manipulate and transform data represented as physical (electronic) quantities within a computer system's registers and memories into other data similarly represented as physical quantities within the computer system memories or registers or other such information storage, transmission or display devices.

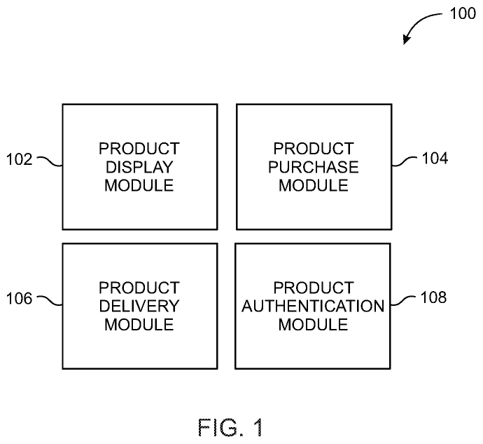

Referring to FIG. 1, a block diagram illustrates a system 100 and its various modules for carrying out various instructions for providing digital experience, such as digital commerce, for aspects of a community in accordance with an exemplary embodiment of the invention. The digital commerce may provide a user with options for performing online shopping and resale capabilities for various types of products, such as retail merchandise, health products, electronics, home needs, books, hygiene products and the like. In some example embodiments, system 100 provides a digital experience for users of a community. The community may be a product centric community. In some example embodiments, the product may be sneakers. System 100 may provide users of the sneaker community, such as users interested a plurality of activities related to sneakers, such as buying, selling, reviewing, discussing, rating, promoting, marketing, or simply surfing on the internet about sneakers.

System 100 may include various modules such as a product display module 102, a product purchase module 104, a product delivery module 106, and a product authentication module 108. In some example embodiments, the various modules 102-108 may for part of a server, and may also include computer code in the form of computer-executable instructions. The computer code may be stored, such as in a memory (not shown), that may be used to store various set of instructions which may be executed when called upon or initiated, for various modules to carry out the functionalities as disclosed herein. The memory may be non-transitory and may include, for example, one or more volatile and/or non-volatile memories. For example, the memory may be an electronic storage device (for example, a computer readable storage medium) comprising gates configured to store data (for example, bits) that may be retrievable by a machine (for example, a computing device like the processor).

In some example embodiments, system 100 may include a processor to carry out the functionalities of the different modules as disclosed herein. The processor may include a circuitry which may further include at least one processor, at least one memory, and a communication interface. Additional, fewer, or different components may also be possible. The processor may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like.

System 100 may also include communication interfaces, such as an input interface and an output interface for supporting communications to and from the various modules. The communication interface may be any means such as a device or circuitry embodied in either hardware or a combination of hardware and software that is configured to receive and/or transmit data to/from system 100. In some examples, system 100 may be a computing server or the like. System 100 may comprise one or more physical packages (for example, chips) including materials, components and/or wires on a structural assembly (for example, a baseboard). The structural assembly may provide physical strength, conservation of size, and/or limitation of electrical interaction for component circuitry included thereon.

In some example embodiments, system 100 may be embodied as a chip or chip set. In other words, system 100 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. System 100 may therefore, in some cases, be configured to implement an example embodiment of the present invention on a single “system on a chip.” As such, in some cases, a chip or chipset may constitute a means for performing one or more operations for providing the functionalities described herein.

The processor (and/or co-processors or any other processing circuitry assisting or otherwise associated with the processor) may be in communication with the memory via a bus for passing information among components of system 100. The processor may be configured to execute instructions stored in the memory or otherwise accessible to the processor. Additionally, or alternatively, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. The processor may include, among other things, a clock, an arithmetic logic unit (ALU) and logic gates configured to support operation of the apparatus.

In some example embodiments, system 100 may include computer-executable instructions in the form of a website or an application, wherein the website or application accessed by a user device. For example, the computer code may be accessed by downloading an application or “app” on the user device, wherein the app may be a digital commerce app. The user device may be any of a smartphone, a laptop, a tablet computer, a smartwatch, a personal computer and the like on which computer code corresponding to the app may be encoded, such as by downloading, in any readily available coding languages like python, java, and the like. Further, the computer code may be configured so as to be fit for any operating software requirements and compatibility. In some example embodiments, the computer code, in the form of the app may be downloaded from a specific application marketplace, such as a website of a digital commerce vendor, that may provide different versions of the app for smartphones or tablets of different OS.

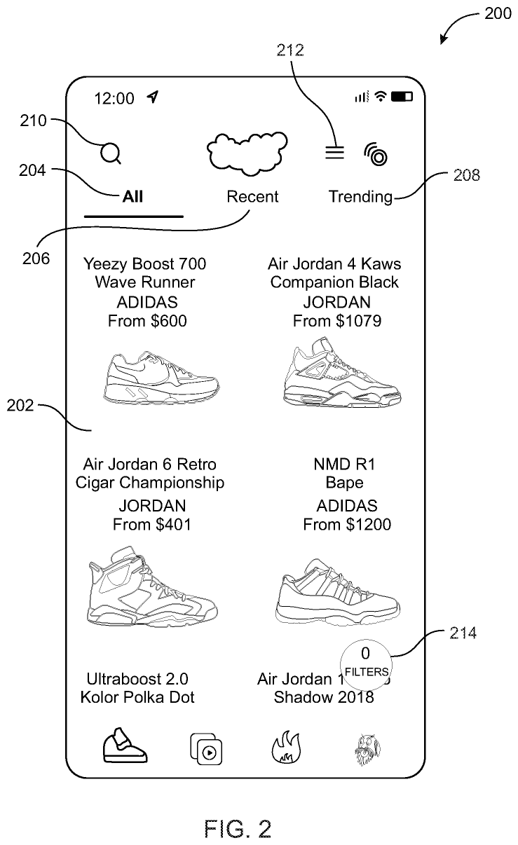

System 100 includes product display module 102 that may be configured for performing product display functions. Thus, the memory may store product display instructions to enable providing of information about one or more products to a user. Product display module 102 may display a product display page 200, as shown in FIG. 2.

FIG. 2 exemplarily illustrates a diagram of display of a product on a display page generated by product display module 102 according to product display instructions. Product display page 200 includes multiple page sections. One of the sections is a product list display 202. In some example embodiments, product list display 202 may be a default display and may be a landing page for the product display page. Further, product display page 200 may include an all products tab 204 that displays all products listed on the product list. Further, product display page 200 may include a recent products tab 206 that may display recent products sold or bought by the user. Further product display page 200 may include a trending tab 208 that may display products that may be trending currently, such as for 24-36 hours, or are being discussed currently in social media, in news, on product community pages and the like. Further product display page 200 may also further include a search tab 210.

When logged-on to the webpage, the marketplace platform user may be able to search for products using specific names, company, type and the like. Product display page 200 may also include a change view tab 212 through which the user may be able to change the display settings for product list display, such as from grid to a continuous list view and other such options. There may also be provided a filter tab 214 that may be used by the user to filter the various products listed on the product display page by size, color, date of manufacture, delivery time, and the like.

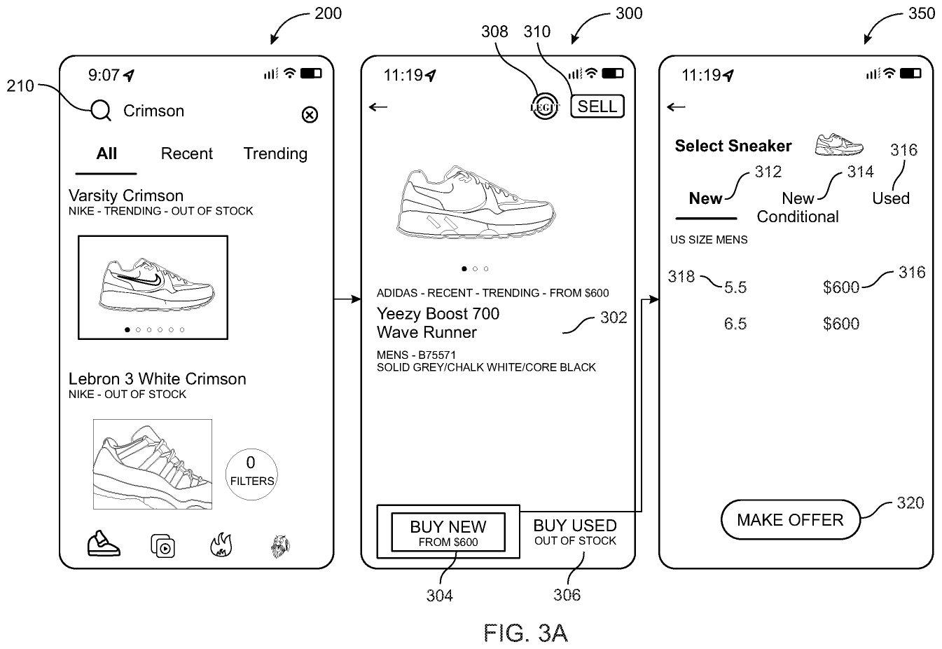

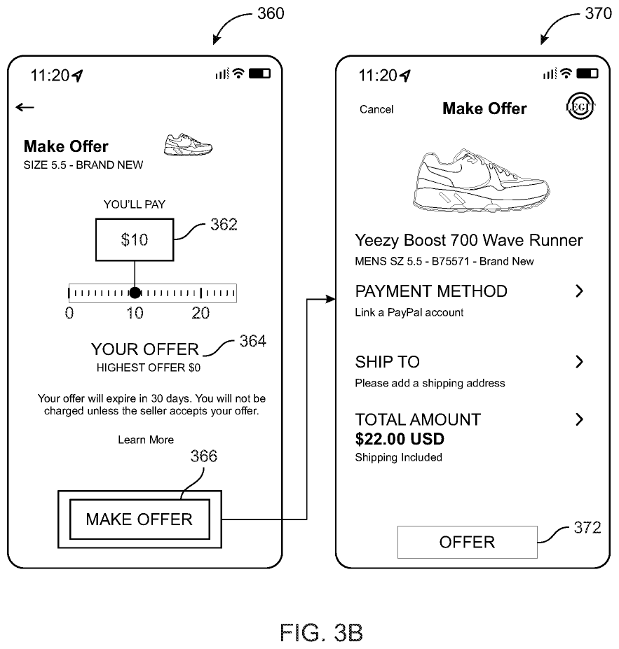

System 100 further includes product purchase module 104 configured for performing product purchase functions. Thus, the memory may store product purchase instructions to enable purchasing of at least one or more products by the user. Product purchase module 104 on initiation may display a product purchase display 300 as shown in FIGS. 3A and 3B. Product purchase module 104 may be initiated when a user while browsing the product display page, may click on a commercial product (also interchangeable referred to as the product) as displayed in FIG. 3A. The example of FIG. 3A displays that the product is a sneaker.

However, the invention may also be applicable to other products, as the example of a sneaker is for illustrative purpose only and does not limit the scope of the invention, as may be understood by a person of ordinary skill in the art. Further, purchase page 300 may be generated on execution of the product purchase instructions. The action displayed in FIG. 3A illustrates that the product purchase page 300 that may include various tabs for various functions. Product purchase page 300 may include a product information area 302 that provides information and specifications about the product. It may also include various pictures from different angles that may be available on swiping from left to right or from top to bottom. Product purchase page 300 further may include a purchase tab 304/306 which on activation, such as by clicking or selecting purchase tab 304/306, brings the user to next page of product purchase page 300. Purchase tab 304 may provide the user to buy a new product, and purchase tab 306 may provide the user with the option to buy a used product.

Thus, system 100 also provides the capability for resale of a product to the user, which is not provided by the systems and methods available in the art. Further, product purchase page 300 may also include authenticated information display area 308 wherein if the product to be purchased is authenticated by a seller may be displayed. This may offer the advantage of buying a genuine product, which is pre-authenticated using a robust authentication mechanism, thereby providing a guarantee of high-quality products being sold to the user, through system 100 presented by the various example embodiments disclosed herein.

Further, product purchase page 300 may also include a sell tab 310 to enable user to sell that particular product if they want. When the user choses or presses purchase tab 304/306, they are navigated to next screen that is screen 350 of product purchase page 300. This page may further include multiple tabs for various functions. Screen 350 may include a product specification choosing area 318 where user may be able to choose product specification as to their choices like color, size, etc. Further, screen 350 may also include product condition tabs like 312, 314, 316 to choose whether the user wants to buy a new product, a new product with conditions or a used product respectively. Screen 350 may also have a pricing information area 320 to display tentative pricing of product based on user's choices.

Lastly, screen 350 may also include a make offer tab 322. A user may make an offer for selling the product by clicking make offer tab 322 and subsequently, they may be navigated to another screen 360, as shown in FIG. 3B. Thus, make offer tab 322 may enable the user to become a part of a product resale community, whereby the users resell their products using system 100 disclosed in the invention herein. For example, the user may be a part of a sneaker resale, and may also offer to resell their pair of sneakers by quoting a resell price for the sneaker. Thus, screen 360 may further include an offer tab 362 wherein the user may enter an amount to make an offer. For example, screen 360 illustrates a user interested in reselling their sneaker for USD 10. There may also be an offer information area 364 on screen 360 to display offer details. Further, on clicking a make offer tab 366, the user may be navigated to a screen 370 that provides a final display of the offer details and makes an offer by clicking offer tab 372.

Once the user has made an offer for selling the product, the further processing may be handled by a payment processing module (not shown), which may include payment details of the user, integrated with product purchase module 104, and stored in a profile of the user. After payment processing, the product may be ready for delivery, and further processing functions may be handled by product delivery module 106. System 100 further includes product delivery module 106 configured for performing product delivery functions. Thus, the memory may store product delivery instructions to enable delivery tracking of the at least one or more products purchased by the user. The product delivery module 106 may be configured to track delivery of the product. For this, product delivery module 106 may be integrated with a location capturing module or GPS module of the user device and may provide a delivery schedule based on the current location of the user.

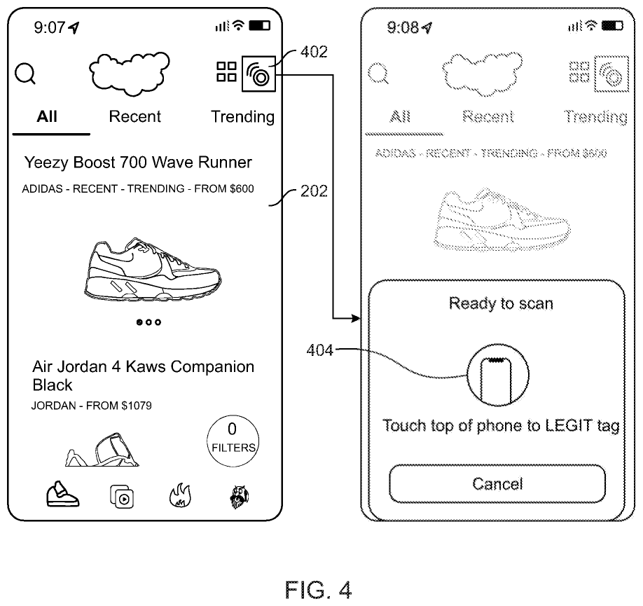

System 100 further includes product authentication module 108 configured for performing product authentication functions. Thus, the memory may store product authentication instructions to enable capturing details of an authenticated product by system 100. In some example embodiments, the product authentication details may be captured by scanning an authentication tag attached to a product. Referring to FIG. 4, product-authentication module 108 displays an authentication tab 402 on product display page 200. On clicking authentication tab 402, the user is displayed with an authentication pop-up 404 that provides the user with instructions on how to perform the authentication. In some example embodiments, the authentication may be performed by tapping the user device on an authentication tag that may be a short-range wireless communication tag like near field communication (NFC) tag. The authentication tag may be attached to the product and may be void/inoperable when not attached to the product.

In some example embodiments, product-authentication module 108 may also provide an option of a non-authenticated product buyer to have the non-authenticated product authenticated by getting it authenticated from a third-party authenticator. The third-party authenticator may physically examine the product and affix an authentication tag to genuine products that may be scanned using product authenticator module 108.

In some example embodiments, system 100 and modules 102-108 may be machine readable instructions which, when executed by a processor/processing module may be configured to perform any of the described functionalities. The machine-readable instructions may be stored on an electronic memory device, hard disk, optical disk or other machine-readable storage medium or non-transitory medium.

In some example embodiments, the machine-readable instructions may be downloaded to the storage medium via a network connection. The network may be a wired communication network, a wireless communication network, or any combination of wired and wireless communication networks, such as, cellular networks, Wi-Fi, internet, local area networks, or the like.

In one embodiment, the network may include one or more networks, such as, a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof.

In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In some example embodiments, the machine-readable instructions may be stored on a server in the form of an algorithm, which when executed, may cause system 100 to provide a user, such as a user of a product community with a digital experience regarding a product. In some example embodiments, the product may be sneaker and the user may be a part of a sneaker community, such as a user interested in buying a sneaker, selling a sneaker, reselling a sneaker, posting reviews about used sneakers on virtual forums, social networking sites, blogs and the like.

In some example embodiments, the digital experience may include providing two-way communication between members of a community. For example, system 100 may provide facilities for performing a two-way communication between a first member of the community and a second member of the community. The two-way communication may comprise receiving a proposal for a commercial transaction from the first member to the second member of the community. The two-way communication may also include performing completion of the proposed commercial transaction between the first member and the second member. Also, the two-way communication may include directing shipping of a product that is related to the completed commercial transaction and further posting a review about the community and the completed commercial transaction, wherein posting the review includes displaying information about the product to a user of the community.

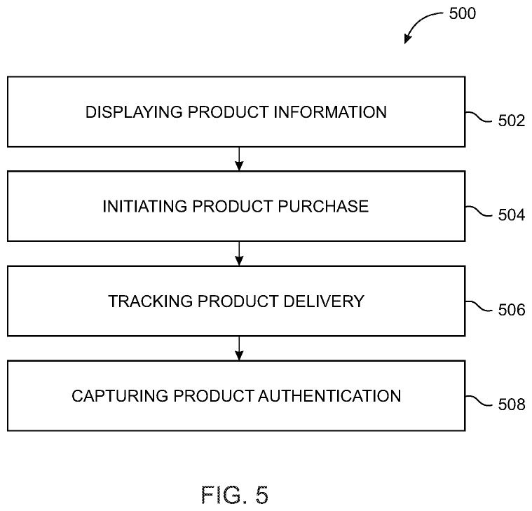

In some example embodiments, system 100 may be configured to provide digital experience to members of the community in accordance with a method illustrated in FIG. 5.

FIG. 5 illustrates a flowchart of a workflow, according to example embodiments of the present invention. Accordingly, blocks of the flowchart pertain to means for performing the specified functions and to operations of those means for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

At step 502, method 500 may include displaying information about one or more products to a user of the community. The information may include various aspects of the product such as photographs, color, size, price, authentication information and the like. At step 504, method 500 may include determining initiating a product purchase to enable the user to purchase the product. The user may decide to purchase the displayed product, and their payment information may be integrated into their profile while they are viewing the product, such as using a website of a marketplace service provider. Once the user has bought the product by making the payment for the price of the product, at step 506, method 500 may include tracking the delivery of the product, such as using product location, derived from GPS data.

In some example embodiments, tracking product delivery may include displaying a delivery schedule for the product to the user, based on the location details of the user and the product. At step 508, method 500 may include capturing product authentication information by scanning an authentication tag attached to the product. In some example embodiments, the product one authenticated may be added to the user profile.

In some example embodiments the authentication tag is one of a bar code, a QR code, a holographic image, or a near field communication authentication tag. The authentication tag may work only when attached to the product, and may be rendered inoperable when detached from the product.

In some example embodiments, method 500 may also enable the user to sell, resell, or make a price offer for selling the product. Method 500 may also provide for displaying of plural virtual events associated with the products, such as on a website. The plural virtual events may include a social community event, a virtual auction, a virtual sale, a virtual forum, a virtual discussion, an e-commerce event like buying or selling of the product and the like. In some example embodiments, the community may be a commercial product community, wherein the product may be a sneaker. In some embodiments, the community may be the sneaker resale community.

In an example embodiment, a system for performing the method of FIG. 5 above may include a user device configured to perform some or each of the operations (502-508) described above. The user device may, for example, be configured to perform the operations (502-508) by performing hardware implemented logical functions, executing stored instructions, or executing algorithms for performing each of the operations. Alternatively, the system may include means for performing each of the operations described above. In this regard, according to an example embodiment, examples of means for performing operations 502-508 may include, for example, a device or circuit for executing instructions or executing an algorithm for processing information as described above.

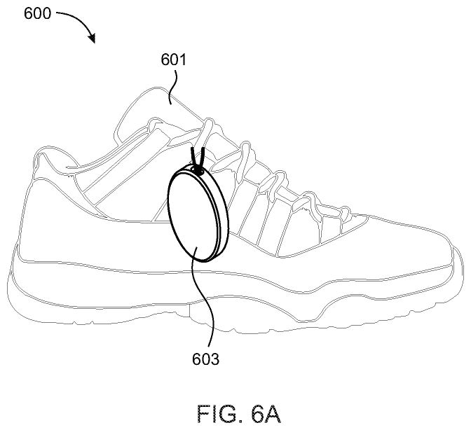

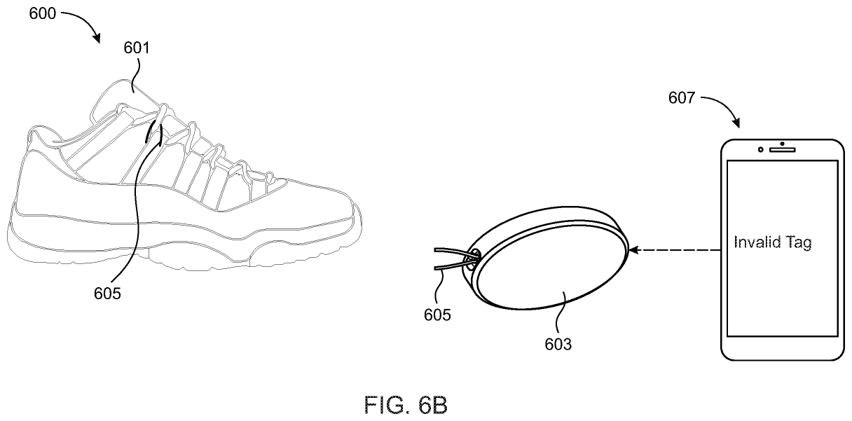

FIGS. 6A-6B illustrates an authentication 603 tag attached to a product 600 and detached from the product respectively. The product is a sneaker. A scanning device 607 may perform authentication upon being tapped by authentication tag 603 attached to sneaker 600. Authentication tag may be a short-range-wireless-communication tag, for example, a near-field-communication (NFC) tag. Authentication tag 603 can be attached to any part of sneaker 600. The various parts of sneaker 600 where authentication tag 603 may be connected are tongue 601, heel cap, sole, welt, toe box, and throat. Pin engage tubes may be used to form a circuit connection for authentication tag 603 with sneaker 600.

In some example embodiments, pin and tube engagement assemblies may help secure the strap (thread 605) of the authentication tag around the sneaker. Such assemblies may function as a circuit-breakers for the internal circuitry of authentication tag 603 such that when the tag is detached from the sneaker, i.e. the pin tube assembly is disengaged, the internal circuitry, for example an NFC circuitry, may not operate, thereby rendering the authentication tag inoperable. In some example embodiments, the disengagement of the pin-tube assembly may trigger a separate circuitry inside the tag which transmits error/invalid message when scanned by a scanning device. Although, NFC may be the prevalent electronic communication means for the authentication tag, various other modes to communicate the error/invalid message may be possible within the scope of the disclosure.

The tag may be programmed so that it cannot function when not suitably attached to a to-be-authenticated product. When authentication tag is not suitably attached or detached from sneaker 600, it creates a circuit breaker. The scanning of a detached tag will result in display of invalid tag message on the display of scanning device 607. Authentication tag 603 is said to be detached when thread 605 is not a part of the closed circuit with sneaker 600.

In some example embodiment, NFC components can be active NFC, passive NFC or any combination thereof. Active NFC coupled with the scanning device provides a two-way handshake to validate a communication between authentication tag 603 and scanning device 607. This way a more secure authentication tag which works only when attached to the product (sneaker 600) may be provided.

The invention may also be described in the following numbered paragraphs.

1. A device for providing a digital experience of aspects of a community, the device comprising:

at least one memory configured to store computer-executable instructions; and

at least one processor configured to execute the instructions to:

display information about one or more products to a user of the community;

initiate a product purchase to enable the user to purchase at least one of the one or more products;

track product delivery of the at least one or more purchased products; and

capture product authentication information by scanning an authentication tag attached to the at least one of the one or more products.

2. The device of paragraph 1, wherein the at least one processor is further configured to provide access to one or more of a website or an application to a user device.

3. The device of paragraph 2, wherein the at least one processor is further configured to transmit computer code on the user device to provide the digital experience.

4. The device of paragraph 1, wherein to capture the product authentication information, the at least one processor is further configured to add the authenticated product to a user profile of the user.

5. The device of paragraph 1, wherein the authentication tag is one of a bar code, a QR code, a holographic image, or a near field communication authentication tag.

6. The device of paragraph 5, wherein the authentication tag is rendered inoperable when detached from the product.

7. The device of paragraph 1, wherein the at least one processor is further configured to enable the user to sell the one or more products.

8. The device of paragraph 1, wherein the at least one processor is further configured to enable the user to make a price offer for selling the one or more products.

9. The device of paragraph 1, wherein the at least one processor is further configured to identify and display a plurality of virtual events associated with the at least one of the one or more products.

10. The device of paragraph 1, wherein the plurality of virtual events includes a social community, a virtual auction, a virtual sale, a virtual forum, a virtual discussion, or an e-commerce event.

11. The device of paragraph 1, wherein the community comprises a commercial product community.

12. The device of paragraph 1, wherein the commercial product is a sneaker.

13. The device of paragraph 1, wherein the community is a sneaker resale community.

14. A computer-implemented method for providing a digital experience of a community, comprising:

performing a two-way communication between a first member of the community and a second member of the community, wherein the two-way communication comprises performing at least one of:

receiving a proposal for a commercial transaction from the first member to the second member;

enabling completion of the proposed commercial transaction between the first member and the second member;

directing shipping of a product that is related to the completed commercial transaction; and

posting a review about the community and the completed commercial transaction, wherein posting the review includes displaying information about the product to a user of the community.

15. The method of paragraph 14, wherein the community comprises a commercial product community.

16. The method of paragraph 15, wherein the product is a sneaker.

17. The method of paragraph 15, wherein the community is a sneaker resale community.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A computer-implemented system for providing a digital experience of aspects of a community, the system comprising:
one or more databases configured to store data of one or more products; and
a server, comprising:
at least one memory configured to store computer-executable instructions comprising:
product display instructions for providing information about the one or more products to a user of the community;
product purchase instructions for enabling the user to purchase at least one of the one or more products;
product delivery instructions for enabling delivery tracking of the purchased at least one of the one or more products; and
product authentication instructions for capturing details of an authenticated product by scanning an authentication tag attached to at least one of the one or more products; and
at least one processor configured to execute the computer-executable instructions to provide the digital experience.

2. The system of claim 1, wherein the computer-executable instructions comprise one or more of a website or an application that is accessible by a user device.

3. The system of claim 2, wherein the computer-executable instructions are downloaded to the user device for providing the digital experience.

4. The system of claim 1, wherein the at least one processor is configured to execute the product authentication instructions for enabling adding of the authenticated product to a user profile of the user.

5. The system of claim 1, wherein the authentication tag is one of a bar code, a QR code, a holographic image, or a near field communication authentication tag.

6. The system of claim 1, wherein the authentication tag is rendered inoperable when detached from the product.

7. The system of claim 1, wherein the at least one processor is configured to execute the product purchase instructions for enabling the user to sell the one or more products.

8. The system of claim 7, wherein the at least one processor is further configured to execute the product purchase instructions to enable the user to make a price offer for selling the one or more products.

9. The system of claim 1, wherein the at least one processor is further configured to execute the computer-executable instructions to identify and display a plurality of virtual events associated with the at least one of the one or more products.

10. The system of claim 9, wherein the plurality of virtual events include a social community, a virtual auction, a virtual sale, a virtual forum, a virtual discussion, or an e-commerce event.

11. The system of claim 1, wherein the product purchase information is integrated with payment details of the user.

12. The system of claim 1, wherein the product delivery instructions associated with product delivery data integrated with location capturing data that captures current location of the user and provides a delivery schedule based on the current location.

13. The system of claim 1, wherein the community comprises a commercial product community.

14. The system of claim 13, wherein the commercial product is a sneaker.

15. The system of claim 14, wherein the community is a sneaker resale community.

16. A computer-implemented method for providing a digital experience of aspects of a community, comprising:
displaying information about one or more products to a user of the community;
initiating a product purchase to enable the user to purchase at least one of the one or more products;
tracking product delivery of the purchased at least one of the one or more products; and
capturing product authentication information by scanning an authentication tag attached to the at least one of the one or more products.

17. The method of claim 16, further comprising providing access to one or more of a website or an application to a user device.

18. The method of claim 17, further comprising downloading computer code on the user device.

19. The method of claim 16, wherein capturing the product authentication information further comprises adding the authenticated product to a user profile of the user.

20. The method of claim 16, wherein the authentication tag is one of a bar code, a QR code, a holographic image, or a near field communication authentication tag.

21. The method of claim 16, wherein the authentication tag is rendered inoperable when detached from the product.

22. The method of claim 16, further comprising enabling the user to sell the one or more products.

23. The method of claim 22, further comprising enabling the user to make a price offer for selling the one or more products.

24. The method of claim 16, further comprising identifying and displaying a plurality of virtual events associated with the at least one of the one or more products.

25. The method of claim 24, wherein the plurality of virtual events include a social community, a virtual auction, a virtual sale, a virtual forum, a virtual discussion, or an e-commerce event.

26. The method of claim 16, wherein the community comprises a commercial product community.

27. The method of claim 26, wherein the commercial product is a sneaker.

28. The method of claim 27, wherein the community is a sneaker resale community.
